(19) United States
(12) Patent Application Publication
(10) Pub. No.: US 2026/0136096 A1
(43) Pub. Date: May 14, 2026

(54) LENS APPARATUS AND IMAGE PICKUP APPARATUS

(71) Applicant: CANON KABUSHIKI KAISHA, Tokyo (JP)

(72) Inventor: CHINAMI YOKOZEKI, Tochigi (JP)

(21) Appl. No.: 19/331,068

(22) Filed: Sep. 17, 2025

(30) Foreign Application Priority Data
Nov. 8, 2024 (JP) 2024-195771

(51) Int. Cl. H04N 23/67; G02B 7/14; G02B 7/36; G03B 17/14; H04N 23/55

(52) U.S. Cl. CPC H04N 23/672; G02B 7/14; G02B 7/36; G03B 17/14; H04N 23/55

(57) ABSTRACT

Lens apparatuses and image pickup apparatuses are provided herein. One or more lens apparatuses attachable to and detachable from an image pickup apparatus may include a first lens configured to change an aberration by being inserted into and removed from an optical path, and one or more processors that, upon execution of instructions, operate to acquire a value relating to a state corresponding to an amount of the aberration using first information relating to whether or not the first lens is inserted into the optical path, and transmit the value to the image pickup apparatus.

### BACKGROUND

### Field of the Technology

The aspect of the disclosure relates to one or more embodiments of a lens apparatus and an image pickup apparatus.

### Description of the Related Art

Imaging using a lens apparatus that includes a lens configured to intentionally generate a spherical aberration (a soft focus lens) can provide an object with a blurred foreground and background, as in cinema moving images, to make a soft image.

Japanese Patent Application Laid-Open No. 2015-87703 discloses a method using, in a case where a detection result of phase-difference autofocus (AF) does not satisfy a predetermined condition, a detection result of a more accurate contrast AF.

### SUMMARY

One or more embodiments of a lens apparatus according to one or more aspects of the disclosure attachable to and detachable from an image pickup apparatus may include a first lens configured to change an aberration by being inserted into and removed from an optical path, and one or more processors that, upon execution of instructions, operate to acquire a value relating to a state corresponding to an amount of the aberration using first information relating to whether or not the first lens is inserted into the optical path, and transmit the value to the image pickup apparatus. One or more embodiments of an image pickup apparatus according to one or more aspects of the disclosure attachable to and detachable from the above lens apparatus may include an image sensor, and one or more processors that, upon execution of an instruction, operate to receive the value from the lens apparatus. Alternatively, one or more embodiments of an image pickup apparatus according to one or more aspects of the disclosure may include an image sensor, a first lens configured to change an aberration by being inserted into and removed from an optical path, and one or more processors that, upon execution of an instruction, operate to acquire a value relating to a state corresponding to an amount of the aberration using first information relating to whether or not the first lens is inserted into the optical path.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram of an imaging system according to a first embodiment.

FIG. 2 is a flowchart illustrating soft-focus-degree information generation processing according to the first embodiment.

FIG. 3 is a flowchart illustrating AF control parameter setting processing according to the first embodiment.

FIGS. 4A and 4B illustrate a relationship between a contrast peak and a threshold value for peak determination in the first embodiment.

FIG. 5 is a block diagram of an imaging system according to a second embodiment.

FIG. 6 is a flowchart illustrating AF method information generation processing in the second embodiment.

FIG. 7 is a flowchart illustrating AF enable/disable switching processing in the second embodiment.

FIG. 8 is a flowchart illustrating the AF enable/disable switching processing in the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

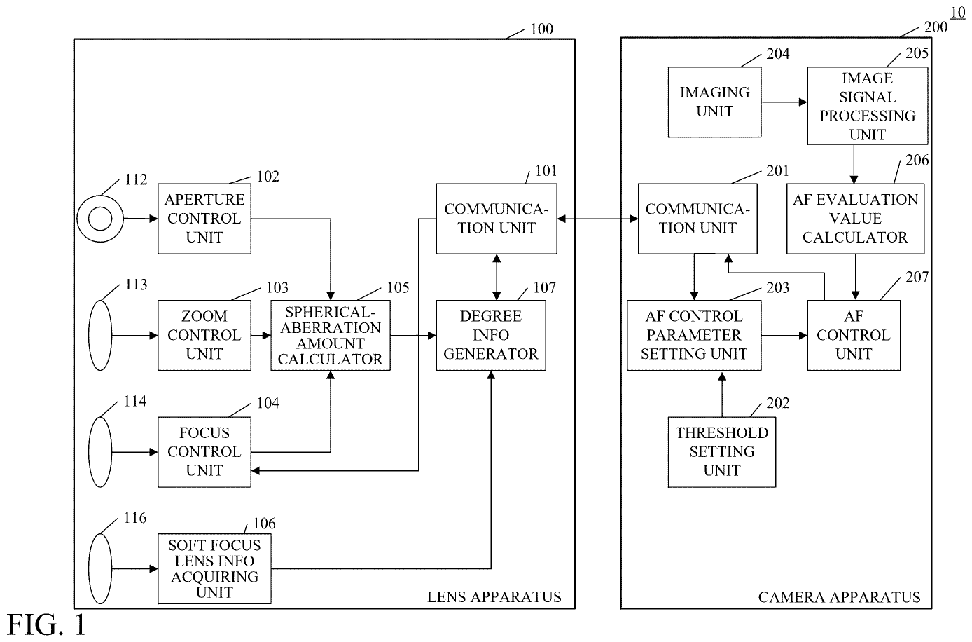

Referring now to FIG. 1, a description will be given of an imaging system 10 according to a first embodiment of the disclosure. FIG. 1 is a block diagram of the imaging system 10. The imaging system 10 includes a camera apparatus (camera body, image pickup apparatus) 200 and a lens apparatus (interchangeable lens) 100 attachable to and detachable from the camera apparatus 200. However, the present embodiment is not limited to this example, and can also be applied to an image pickup apparatus in which the camera body and the lens apparatus are integrated. In an image pickup apparatus in which the camera body and the lens apparatus are integrated, a communication unit for the camera body and the lens apparatus to communicate with each other may be omitted.

First, the lens apparatus 100 will be described. The lens apparatus 100 includes a communication unit (communication unit) 101, an aperture control unit 102, a zoom control unit 103, a focus control unit 104, a spherical-aberration (generation) amount calculator 105, a soft-focus-lens information acquiring unit 106, and a degree information generator (acquiring unit, one or more processors) 107. The lens apparatus 100 further includes an imaging optical system that includes an aperture stop 112, a zoom lens (third lens) 113, a focus lens (second lens) 114, and a soft focus lens (first lens) 116. The aperture stop 112 changes an aperture size to adjust a light amount. The zoom lens 113 moves in the optical axis direction during zooming. The focus lens 114 moves in the optical axis direction during focusing. The soft focus lens 116 is a lens configured to change aberration in a case where the soft focus lens 116 is inserted into or removed from the optical axis (optical path).

The communication unit 101 is connected to the degree information generator 107, and acquires soft-focus-degree information (a value relating to a state according to the amount of aberration) generated by the degree information generator 107. The soft-focus-degree information is expressed as a numerical value between 0(%) and 100(%), for example. The communication unit 101 is also connected to the camera apparatus 200 and can communicate with the camera apparatus 200, and transmits soft-focus-degree information acquired from the degree information generator 107 to the camera apparatus 200. The communication unit 101 is also connected to the focus control unit 104, and transmits a drive command received from the camera apparatus 200 to the focus control unit 104.

The aperture control unit 102 controls the position (aperture position, aperture amount) of the aperture stop 112. The aperture control unit 102 is connected to the spherical-aberration amount calculator 105, and outputs information on the current aperture position (aperture amount of the aperture stop) to the spherical-aberration amount calculator 105.

The zoom control unit 103 controls the position (zoom position) of the zoom lens 113. The zoom control unit 103 is connected to the spherical-aberration amount calculator 105 and outputs information on the current zoom position to the spherical-aberration amount calculator 105.

The focus control unit 104 controls the position (focus position) of the focus lens 114. The focus control unit 104 is connected to the spherical-aberration amount calculator 105, and outputs information on the current focus position to the spherical-aberration amount calculator 105. The focus control unit 104 also drives the focus lens 114 in the optical axis direction based on a drive command received from the camera apparatus 200 via the communication unit 101.

The spherical-aberration amount calculator 105 calculates a spherical aberration amount using the acquired aperture position, zoom position, and focus position. The spherical-aberration amount calculator 105 is also connected to the degree information generator 107, and outputs the calculated spherical aberration amount (second information on the state of the lens apparatus 100) to the degree information generator 107. The spherical aberration has a characteristic that the more the aperture stop 112 is narrowed, the less the spherical aberration is, and a characteristic that the spherical aberration changes (increases or decreases) according to the focus position and zoom position. Therefore, in a case where the aperture position, zoom position, and focus position are known, a design value of the spherical aberration amount can be calculated. In this embodiment, it is not essential for the spherical-aberration amount calculator 105 to use all of the aperture position, zoom position, and focus position, and the spherical-aberration amount calculator 105 may calculate the spherical aberration amount using information on at least one of the aperture position, zoom position, and focus position.

The soft-focus-lens information acquiring unit 106 is connected to the degree information generator 107. The soft-focus-lens information acquiring unit 106 outputs to the degree information generator 107 soft focus lens presence/absence information (first information on whether the soft focus lens 116 is inserted into the optical path) indicating whether the soft focus lens 116 is currently inserted.

The degree information generator 107 is connected to the spherical-aberration amount calculator 105, and acquires the spherical aberration amount. The degree information generator 107 is connected to the soft-focus-lens information acquiring unit 106 and acquires the presence/absence information (first information) on the soft focus lens 116. The degree information generator 107 generates soft-focus-degree information using the acquired spherical aberration amount (second information) and the presence/absence information (first information) on the soft focus lens, and outputs the generated soft-focus-degree information to the communication unit 101. For example, the degree information generator 107 has a memory (storage unit) configured to store a table illustrating a relationship between the presence/absence information on the soft focus lens 116 and the soft-focus-degree information, and can acquire the soft-focus-degree information from the memory. This table may be a table illustrating a relationship among the presence/absence information on the soft focus lens 116, the soft-focus-degree information, and information on the spherical aberration (generation) amount (second information on the state of the lens apparatus 100).

This embodiment may not use the second information in acquiring the soft-focus-degree information. That is, the degree information generator 107 can acquire the soft-focus-degree information by using the first information without using the second information. Details of the generation of the soft-focus-degree information will be described later.

Next, the camera apparatus 200 will be described. The camera apparatus 200 includes a communication unit 201, a threshold setting unit 202, an AF control parameter setting unit 203, an imaging unit 204, an image signal processing unit 205, an AF evaluation value calculator 206, and an AF control unit 207.

The communication unit 201 is connected to the lens apparatus 100 and receives the soft-focus-degree information generated by the lens apparatus 100. The communication unit 201 is also connected to the AF control parameter setting unit 203 and outputs the received soft-focus-degree information to the AF control parameter setting unit 203.

The threshold setting unit 202 is a user interface (UI) that sets a threshold value (first threshold value) of the soft-focus-degree information for switching AF control. The threshold value can be set by the user, for example, between 0 (%) and 100 (%). The threshold setting unit 202 is also connected to the AF control parameter setting unit 203, and outputs the set threshold value to the AF control parameter setting unit 203.

The AF control parameter setting unit 203 sets (changes) a parameter to be used for AF control (AF processing) based on the received soft-focus-degree information and threshold value (based on a relationship between the soft-focus-degree information and the threshold value). The AF control parameter setting unit 203 selects, for example, whether the parameter to be used for AF control is a first AF control parameter (first parameter) or a second AF control parameter (second parameter) corresponding to a low-contrast period. The AF control parameter setting unit 203 sets the selected parameter as a parameter for the AF control unit 207. Details of the AF control parameter setting processing based on the soft-focus-degree information and the threshold value will be described later.

The imaging unit 204 includes an image sensor such as a Complementary Metal-Oxide-Semiconductor (CMOS) sensor or a Charge Coupled Device (CCD) sensor. The imaging unit 204 photoelectrically converts an optical image formed by the imaging optical system of the lens apparatus 100.

The image signal processing unit 205 is connected to the imaging unit 204 and generates an image signal. The AF evaluation value calculator 206 is connected to the image signal processing unit 205 and extracts a luminance signal from the image signal acquired from the image signal processing unit 205. The AF evaluation value calculator 206 also performs filter processing for the extracted luminance signal, extracts a specific frequency component, and calculates an AF evaluation value for contrast AF control. The AF evaluation value calculator 206 is also connected to the AF control unit 207 and transmits the calculated AF evaluation value to the AF control unit 207.

The AF control unit 207 minutely drives (or controls minute driving of) the focus lens 114 of the lens apparatus 100 via the communication unit 201, and acquires an AF evaluation value from the AF evaluation value calculator 206. The AF control unit 207 repeats minutely driving the focus lens 114 and acquiring the AF evaluation value, and searches for the peak of the AF evaluation value to perform focusing processing. In this embodiment, the threshold setting unit 202, the AF control parameter setting unit 203, the AF evaluation value calculator 206, and the AF control unit 207 constitute a control unit for performing AF processing.

Due to the above configuration, the camera apparatus 200 can switch a parameter for AF control (AF processing) based on the soft-focus-degree information received from the lens apparatus 100 and the threshold value set by the user. Therefore, previously setting the threshold value by the user can automatically switch a parameter for the AF control according to the soft focus degree of the lens apparatus 100. As a result, even when the soft focus lens 116 that realizes a cinematic image is inserted in the optical path, AF processing can be performed with high accuracy.

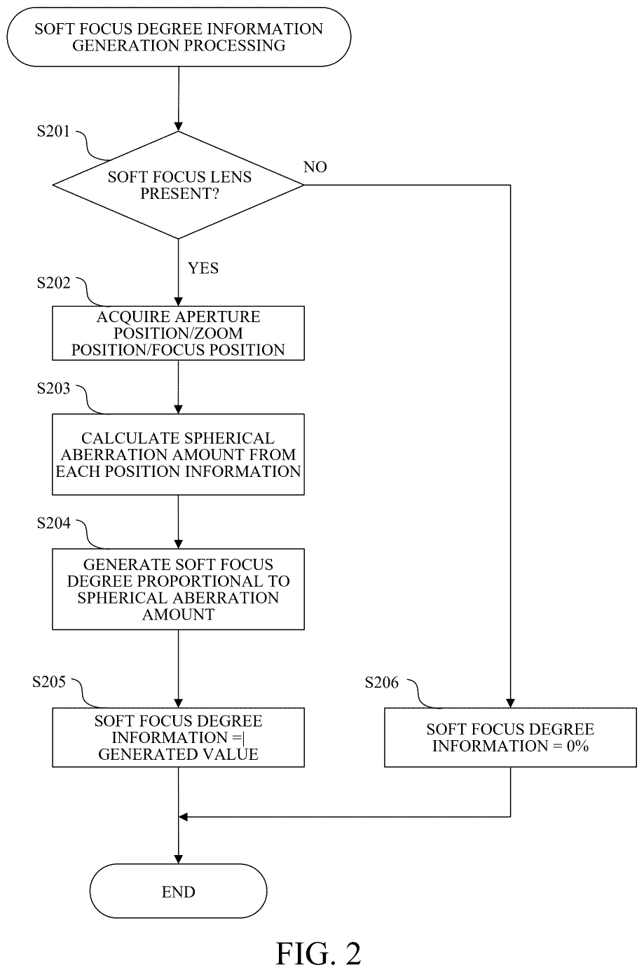

Referring now to FIG. 2, a description will be given of the soft-focus-degree information generation processing (method of controlling the imaging system 10) according to this embodiment. FIG. 2 is a flowchart illustrating the soft-focus-degree information generation processing. This processing is performed periodically in accordance with a computer program stored in the lens apparatus 100.

First, in step S201, the degree information generator 107 acquires information on the presence or absence of the soft focus lens 116 (first information indicating whether the soft focus lens 116 is inserted into the optical path) from the soft-focus-lens information acquiring unit 106, and checks the first information. In a case where the first information indicates “soft focus lens is present” (information indicating a first state in which the soft focus lens 116 is inserted into the optical path), the flow proceeds to step S202. On the other hand, in a case where the first information indicates “soft focus lens is absent” (information indicating a second state in which the soft focus lens 116 is not inserted into the optical path), the flow proceeds to step S206.

In step S202, the spherical-aberration amount calculator 105 acquires the aperture position, zoom position, and focus position. Next, in step S203, the spherical-aberration amount calculator 105 performs a table calculation using the acquired aperture position, zoom position, and focus position to calculate the spherical aberration amount. For example, the spherical-aberration amount calculator 105 has a memory (storage unit) that stores a table illustrating the relationship between the aperture position, zoom position, and focus position and the spherical aberration amount, and can acquire corresponding data from the memory.

Next, in step S204, the degree information generator 107 generates soft-focus-degree information that corresponds to the spherical aberration amount (for example, proportional to the spherical aberration amount).

Next, in step S205, the degree information generator 107 sets the soft-focus-degree information (generated value) generated in step S204 as the soft-focus-degree information, and this flow ends.

In step S206, the degree information generator 107 sets the soft-focus-degree information to 0 (%), and this flow ends.

In this embodiment, in a case where the soft focus lens 116 is not inserted into the optical path, the soft-focus-degree information is set to 0 (%). On the other hand, in a case where the soft focus lens 116 is inserted into the optical path, the soft-focus-degree information is set to a value (for example, a value between 0 and 100 (%)) according to the spherical aberration amount. Thereby, soft-focus-degree information can be automatically generated.

For example, in a case where the spherical aberration amount is the maximum value of the design value, the soft-focus-degree information is set to 100 (%), and in a case where it is the minimum value, it is set to 0 (%). Thereby, soft-focus-degree information on 0 (%) to 100 (%) can be generated according to the design value of the spherical aberration amount. In a case where the spherical aberration amount is an intermediate value between the maximum and minimum values, the soft-focus-degree information is set, for example, to 50 (%). In this embodiment, the soft-focus-degree information is smaller in the second state in which the soft focus lens 116 is not inserted into (is removed from) the optical path than in the first state in which the soft focus lens 116 is inserted into the optical path.

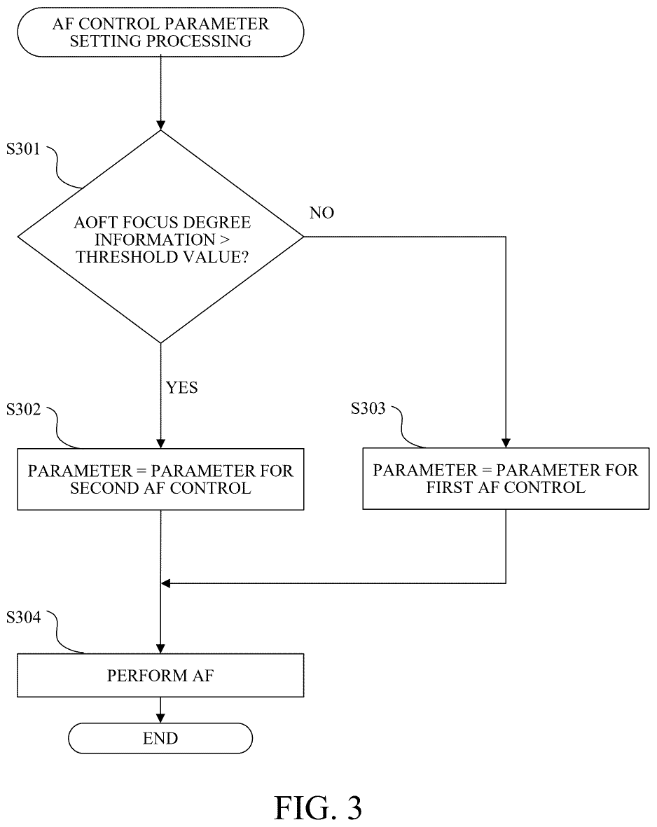

Referring now to FIG. 3, a description will be given of the AF control parameter setting processing (a control method for the imaging system 10) according to this embodiment. FIG. 3 is a flowchart illustrating the AF control parameter setting processing. This processing is performed periodically according to a computer program stored in the camera apparatus 200.

First, in step S301, the AF control parameter setting unit 203 compares the soft-focus-degree information received from the lens apparatus 100 with the threshold value set by the threshold setting unit 202. In a case where the soft-focus-degree information is greater than the threshold value, the flow proceeds to step S302. On the other hand, in a case where the soft-focus-degree information is equal to or less than the threshold value, the flow proceeds to step S303.

In step S302, the AF control parameter setting unit 203 sets, as the AF processing parameter, a second AF control parameter (second parameter) for a peak search method suitable for the characteristic that the change in the AF evaluation value is small even near the focus position of the contrast AF.

In step S303, the AF control parameter setting unit 203 sets, as the AF processing parameter, a first AF control parameter (first parameter) for a peak search method suitable for the characteristic that the change in the AF evaluation value is large near the focus position of the contrast AF.

Next, in step S304, the AF control unit 207 executes AF processing using the AF control parameters (first parameter or second parameter) set by the AF control parameter setting unit 203, and this flow ends.

This embodiment compares the soft-focus-degree information with the threshold value set by the user, and executes AF control for low contrast in a case where the soft focus lens is inserted, only within a soft focus degree range that the user permits.

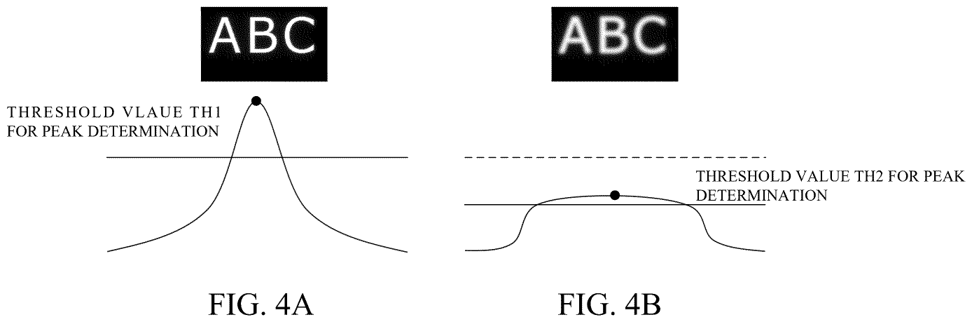

For example, in the second AF control parameter, this embodiment changes one of the parameters, the “threshold value for peak determination of the contrast AF (second threshold value)” according to the soft focus degree. FIGS. 4A and 4B illustrate a relationship between the contrast peak and the threshold value for peak determination (second threshold value). FIG. 4A illustrates the case where the soft focus lens 116 is not inserted (is removed), and FIG. 4B illustrates the case where the soft focus lens 116 is inserted.

In a case where the soft focus degree increases, as illustrated in FIG. 4B, the contrast weakens, and it becomes difficult to find the peak, and AF may not end. Thus, the parameter of the second AF control may be set such that the threshold value for the peak determination is reduced as the soft focus degree increases. In other words, the threshold value for the peak determination differs according to the soft-focus-degree information. For example, in a case where the soft focus degree is 50(%), the threshold value TH2 for the peak determination of the second AF control is set to 50% of the threshold value TH1 for the peak determination set in the parameter for the first AF control.

Thus, changing the threshold value for the peak determination that secures the reliability of the AF determination to a value suitable for the low contrast state in a case where the soft focus lens 116 is inserted can provide AF control while a cinematic image is retained.

Even in the low contrast state in a case where the soft focus lens 116 is inserted, this embodiment can provide AF while retaining a cinematic image, by determining the state of the lens apparatus 100 and switching the contents of the AF control.

This embodiment changes the parameter for the second AF control or the threshold value for the peak determination for the contrast AF in accordance with the soft focus degree, but may not change the threshold value for the peak determination. A parameter may be used as long as it is in accordance with the soft focus degree and enables AF control to be performed while a cinematic image is maintained.

For example, in the case of contrast AF without a threshold value for the peak determination, increasing the search width (lens drive width) in accordance with the soft focus degree can complete the peak search in a shorter time even if the contrast peak is gentle and the search takes a long time. That is, the parameter may include a parameter relating to a search width in searching for a peak in contrast AF. In this case, the search width may be wider in the case of the second parameter than in the case of the first parameter. The search width may also be made different depending on the soft-focus-degree information.

A reduction ratio of the soft focus degree and the threshold value for peak determination regarding the parameter for the second AF control has been described as “1:1” so that for the soft focus degree of 50 (%), 50% of the threshold value for the first AF control is set, but this embodiment may use a configuration in which the user can set it arbitrarily.

There are individual differences in terms of the spherical aberration amount. Thus, the manufacturing error of the spherical aberration amount may be measured and stored in advance, and the manufacturing error may be included in calculating the spherical aberration amount. The spherical aberration amount varies according to the temperature. Thus, the temperature error of the spherical aberration amount generated may be measured and stored in advance, and the temperature error may be included in calculating the spherical aberration amount.

### Second Embodiment

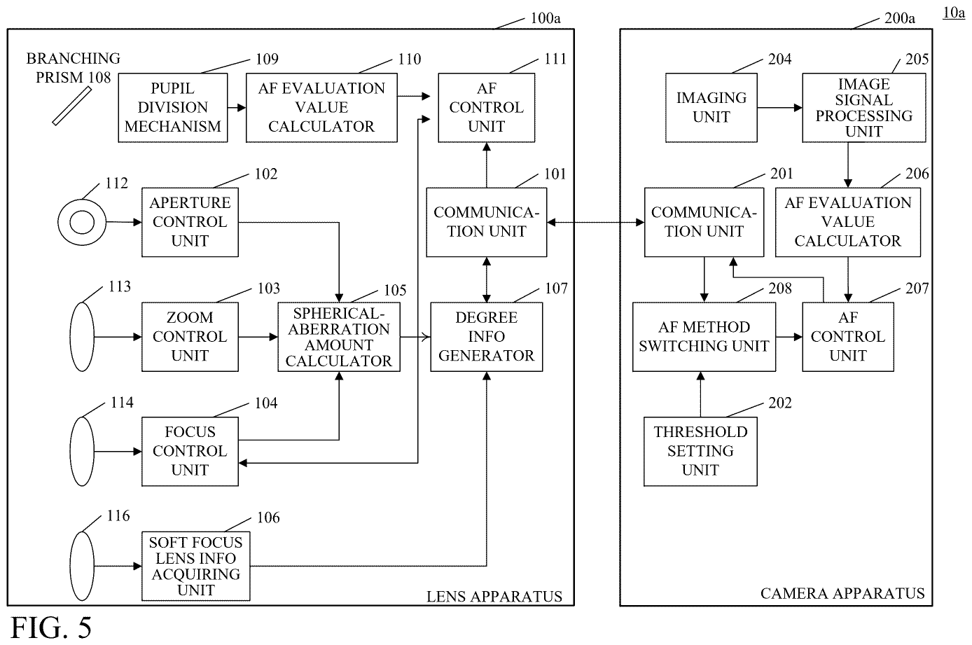

Referring now to FIG. 5, a description will be given of an imaging system 10a according to a second embodiment of the disclosure. FIG. 5 is a block diagram of the imaging system 10a. The imaging system 10a includes a camera apparatus (camera body, image pickup apparatus) 200a and a lens apparatus (interchangeable lens) 100a attachable to and detachable from the camera apparatus 200a. However, this embodiment is not limited to this example, and can also be applied to an image pickup apparatus in which the camera body and the lens apparatus are integrated. Those elements in this embodiment, which are corresponding elements in the first embodiment, will be designated by the same reference numerals, and thus a description thereof will be omitted.

The lens apparatus 100a differs from the lens apparatus 100 of the first embodiment in that a branching prism 108, a pupil division mechanism 109, an AF evaluation value calculator 110, and an AF control unit 111 are added. The camera apparatus 200a differs from the camera apparatus 200 of the first embodiment in that the AF control parameter setting unit 203 is removed from the camera apparatus 200 of the first embodiment and an AF method switching unit 208 is added.

The communication unit 101 is connected to the camera apparatus 200a and receives AF method information by communication with the camera apparatus 200a. The communication unit 101 is also connected to the AF control unit 111 and outputs the AF method information received from the camera apparatus 200a to the AF control unit 111. The focus control unit 104 is connected to the AF control unit 111 and drives the focus lens 114 in the optical axis direction based on the defocus amount acquired from the AF control unit 111.

The branching prism 108 branches a part of the light (amount) from the object. The pupil division mechanism 109 divides the light branched by the branching prism 108 into two light beams for AF control. The AF evaluation value calculator 110 images a pair of light beams split by the pupil division mechanism 109, and calculates an AF evaluation value for phase-difference AF using a phase difference between the two images. The AF evaluation value calculator 110 is also connected to the AF control unit 111, and notifies the AF control unit 111 of the calculated AF evaluation value.

The AF control unit 111 switches between enabling and disabling phase-difference AF, which is the second AF method (second method), using AF method information acquired from the communication unit 101. In a case where phase-difference AF is to be enabled, the AF control unit 111 uses the AF evaluation value acquired from the AF evaluation value calculator 110 to determine whether or not the camera is in an in-focus state. In a case where the camera is not in the in-focus state, the AF evaluation value calculator 110 calculates a defocus amount for focusing based on the AF evaluation value and current position information on the focus lens 114. The AF control unit 111 is also connected to the focus control unit 104, and in a case where the in-focus state is not achieved, it outputs a drive command for the defocus amount to the focus control unit 104 to perform the focusing operation. Details of the AF enable/disable switching processing in the AF control unit 111 using the AF method information will be described later.

The communication unit 201 is connected to the lens apparatus 100a, and transmits the AF method information generated by the AF method switching unit 208 to the lens apparatus 100a. The communication unit 201 is also connected to the AF method switching unit 208, and outputs the soft-focus-degree information (value relating to the state according to the amount of aberration) received from the lens apparatus 100a to the AF method switching unit 208. The threshold setting unit 202 is connected to the AF method switching unit 208, and outputs the set threshold value to the AF method switching unit 208.

The AF control unit 207 switches between enabling and disabling contrast AF, which is the first AF method (first method), using the AF method information acquired from the AF method switching unit 208. Details of the AF enable/disable switching processing in the AF control unit 207 using the AF method information will be described later.

The AF method switching unit 208 generates AF method information based on the received soft-focus-degree information and threshold value. The AF method information is information indicating whether the AF method that is used in the AF processing is to be set to the first AF method, or the second AF method, which is more accurate than the first AF method, when the soft focus lens 116 is inserted. The AF method switching unit 208 is connected to the communication unit 201 and the AF control unit 207, and outputs the generated AF method information. Details of the AF method information generation processing based on the soft-focus-degree information and threshold value will be described later.

In this embodiment, due to the above configuration, AF method information can be generated based on the soft-focus-degree information received from the lens apparatus 100a and the threshold value set by the user, and the AF method can be switched using the AF method information. Therefore, if the user sets the threshold value in advance, the AF method can be automatically switched according to the soft focus degree of the lens apparatus 100a. As a result, the AF accuracy is improved even when the soft focus lens 116 that realizes a cinematic image is inserted.

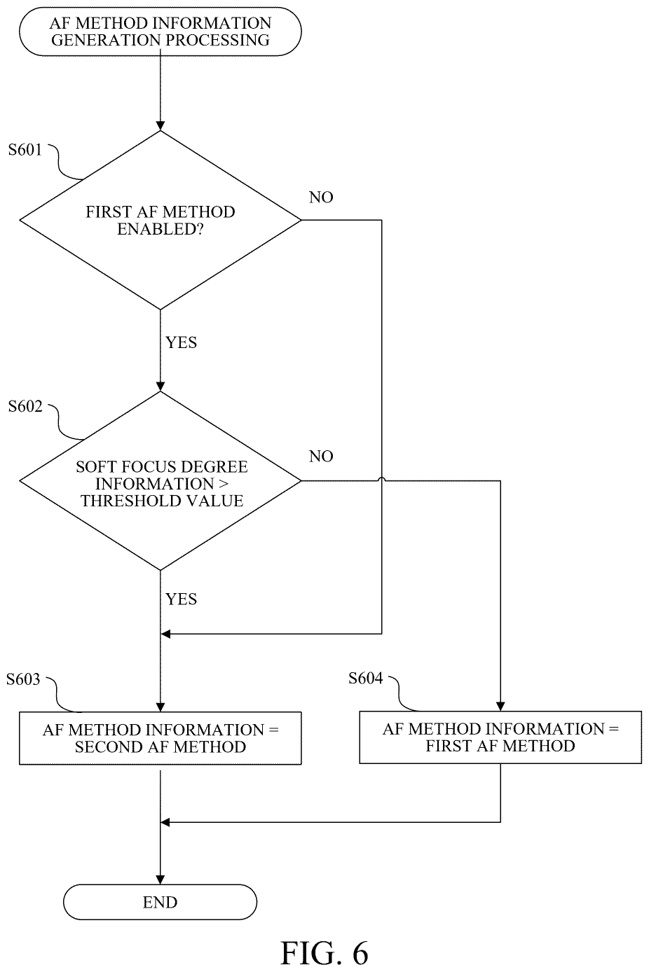

Referring now to FIG. 6, a description will be given of the AF method information generation processing according to this embodiment. FIG. 6 is a flowchart illustrating the AF method information generation processing. This processing is performed periodically according to a computer program stored in the camera apparatus 200a.

First, in step S601, the AF method switching unit 208 determines whether the current AF method set by the user is the first AF method, which is the contrast AF (whether the first AF method is enabled). In a case where the set AF method is the contrast AF, the flow proceeds to step S602. On the other hand, in a case where the set AF method is not the contrast AF, the flow proceeds to step S603.

In step S602, the AF method switching unit 208 compares the soft-focus-degree information received from the lens apparatus 100aa with the threshold value set by the threshold setting unit 202. In a case where the soft-focus-degree information is greater than the threshold value, the flow proceeds to step S603. On the other hand, in a case where the soft-focus-degree information is equal to or less than the threshold value, the flow proceeds to step S604.

In step S603, the AF method switching unit 208 sets the AF method information to the phase-difference AF, which is the second AF method with higher AF accuracy than that of the first AF method, while the soft focus lens 116 is inserted, and the flow ends. In step S604, the AF method switching unit 208 sets the AF method information to the contrast AF, which is the first AF method, and the flow ends.

According to this embodiment, even if the user selects the contrast AF, the soft-focus-degree information can be compared with the threshold value set by the user, and the AF method information can be automatically set to the phase-difference AF only within a range of the soft focus degree that the user can accept.

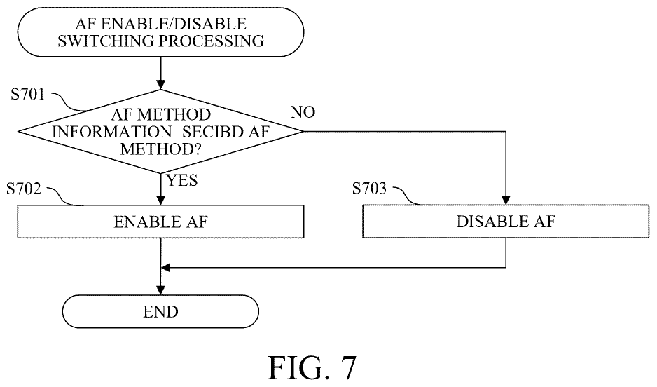

Referring now to FIG. 7, a description will be given of the AF enable/disable switching processing of the AF control unit 111 using the AF method information according to this embodiment. FIG. 7 is a flowchart illustrating the AF enable/disable switching processing. This processing is periodically performed according to a computer program stored in the lens apparatus 100a.

First, in step S701, the AF control unit 111 determines the AF method information received from the camera apparatus 200aa. In a case where the AF method information is the second AF method, the flow proceeds to step S702. On the other hand, in a case where the AF method information is not the second AF method, the flow proceeds to step S703.

In step S702, the AF control unit 111 sets the AF processing to be enabled, and this flow ends. In step S703, the AF control unit 111 sets the AF processing to be disabled, and this flow ends.

In this embodiment, the AF method information generated from the soft-focus-degree information and a threshold value is used to switch between AF enablement and disablement of the lens apparatus 100aa. This allows phase-difference AF to be enabled in the low contrast state while the soft focus lens 116 is inserted.

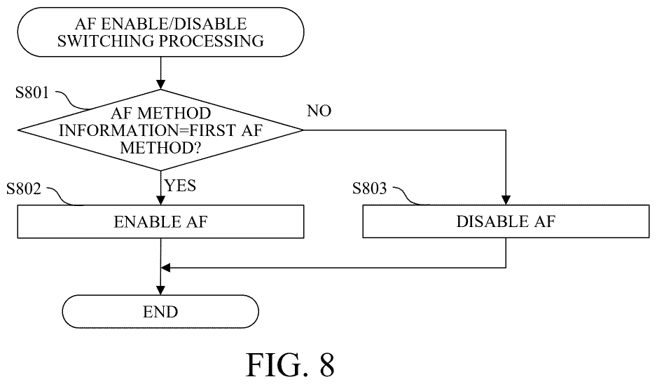

Referring now to FIG. 8, a description will be given of the AF enable/disable switching processing of the AF control unit 207 using the AF method information in this embodiment. FIG. 8 is a flowchart illustrating the AF enable/disable switching processing. This processing is performed periodically according to a computer program stored in the camera apparatus 200a.

First, in step S801, the AF control unit 207 determines the AF method information received from the AF method switching unit 208. In a case where the AF method information is the first AF method, the flow proceeds to step S802. On the other hand, in a case where the AF method information is not the first AF method, the flow proceeds to step S803.

In step S802, the AF control unit 207 sets the AF processing to enabled, and this flow ends. In step S803, the AF control unit 207 sets the AF processing to disabled, and this flow ends.

In this embodiment, the AF enablement and disablement of the camera apparatus 200a is switched using the AF method information generated from the soft-focus-degree information and the threshold value. Thereby, the contrast AF can be disabled in a low contrast state while the soft focus lens 116 is inserted.

For example, the phase-difference AF of the lens apparatus 100a has no effect on the AF accuracy even while the soft focus lens 116 is inserted, because the AF-related optical system is configured before the soft focus lens 116. Therefore, in a low contrast state while the soft focus lens 116 is inserted, the phase-difference AF has higher AF accuracy than that of the contrast AF as the first AF method. Therefore, the more accurate phase-difference AF may be prioritized for a user who uses contrast AF rather than phase-difference AF. While the soft focus lens 116 is inserted, this embodiment can automatically switch to the phase-difference AF only within a range of soft focus degree that the user can accept.

Thus, the control unit for performing the AF processing (threshold setting unit 202, AF control unit 207, and AF method switching unit 208) changes the AF processing method based on the relationship between the soft-focus-degree information and the first threshold value. The control unit may set the method to the first method (first AF method) in a case where the soft-focus-degree information is less than the first threshold value, and sets the method to the second method (second AF method) in a case where the soft-focus-degree information is greater than the first threshold value. The first method may be the contrast detecting method (contrast AF), and the second method is the phase-difference detecting method (phase-difference AF).

In this embodiment, even in a low contrast state while the soft focus lens 116 is inserted, the state of the lens apparatus 100a is determined and the AF method is switched. Thereby, the AF processing can be achieved while a desired image is retained.

In this embodiment, the second AF method is a phase-difference AF, but this embodiment is not limited to this example. The same effect can be obtained by using an AF method that is not affected by contrast, for example, an image-plane phase-difference (detecting) method (image-plane phase-difference AF) that uses image data output from the imaging unit 204, as the second AF method.

Each embodiment according to the disclosure can provide a lens apparatus, an image pickup apparatus, an imaging system, a control method for the lens apparatus, and a storage medium, each of which can perform highly accurate AF.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-195771, which was filed on Nov. 8, 2024, and which is hereby incorporated by reference herein in its entirety.

What is claimed is:

1. A lens apparatus attachable to and detachable from an image pickup apparatus, the lens apparatus comprising:
a first lens configured to change an aberration by being inserted into and removed from an optical path; and
one or more processors that, upon execution of instructions, operate to:
acquire a value relating to a state corresponding to an amount of the aberration using first information relating to whether or not the first lens is inserted into the optical path, and
transmit the value to the image pickup apparatus.

2. The lens apparatus according to claim 1, wherein the first information includes information indicating that the first lens is in a first state in which the first lens is inserted into the optical path, or in a second state in which the first lens is removed from the optical path, and
wherein the amount of the aberration in a case where the first lens is in the second state is smaller than that in a case where the first lens is in the first state.

3. The lens apparatus according to claim 1, wherein the one or more processors obtain the value using second information on a state of the lens apparatus.

4. The lens apparatus according to claim 3, further comprising a second lens configured to move during focusing,
wherein the second information includes information on a position of the second lens.

5. The lens apparatus according to claim 3, further comprising a third lens configured to move during zooming,
wherein the second information includes information on a position of the third lens.

6. The lens apparatus according to claim 3, further comprising:
a second lens configured to move during focusing, and
a third lens that moves during zooming,
wherein the second information includes information on a position of the second lens and information on a position of the third lens.

7. The lens apparatus according to claim 3, further comprising an aperture stop configured to adjust a light amount,
wherein the second information includes information on an aperture amount of the aperture stop.

8. The lens apparatus according to claim 1, wherein the one or more memories store a table indicating a relationship between the first information and the value, and
wherein the one or more processors operate to obtain the value from the one or more memories.

9. An image pickup apparatus attachable to and detachable from the lens apparatus according to claim 1, the image pickup apparatus comprising:
an image sensor; and
one or more processors that, upon execution of an instruction, operate to receive the value from the lens apparatus.

10. An image pickup apparatus comprising:
an image sensor;
a first lens configured to change an aberration by being inserted into and removed from an optical path; and
one or more processors that, upon execution of an instruction, operate to acquire a value relating to a state corresponding to an amount of the aberration using first information relating to whether or not the first lens is inserted into the optical path.

11. The image pickup apparatus according to claim 9, wherein the one or more processors operate to:
perform autofocus processing, and
change a parameter for the autofocus processing based on a relationship between the value and a first threshold value.

12. The image pickup apparatus according to claim 11, wherein the one or more processors operate to:
set the parameter to a first parameter in a case where the value is less than the first threshold value, and
set the parameter to a second parameter if the value is greater than the first threshold value.

13. The image pickup apparatus according to claim 12, wherein the parameter includes a parameter relating to a second threshold value for peak determination in contrast autofocus, and
wherein the second threshold value for the second parameter is lower than the second threshold value for the first parameter.

14. The image pickup apparatus according to claim 13, wherein the second threshold value for peak determination varies according to the value.

15. The image pickup apparatus according to claim 12, wherein the parameter includes a parameter relating to a search width for peak search in contrast autofocus, and
wherein the search width for the second parameter is wider than the search width for the first parameter.

16. The image pickup apparatus according to claim 15, wherein the search width varies according to the value.

17. The image pickup apparatus according to claim 9, wherein the one or more processors operate to:
perform autofocus processing, and
change a method of the autofocus processing based on a relationship between the value and a first threshold value.

18. The image pickup apparatus according to claim 17, wherein the one or more processors operate to:
set the method to a first method in a case where the value is less than the first threshold value, and
set the method to a second method in a case where the value is greater than the first threshold value.

19. The image pickup apparatus according to claim 18, wherein the first method is a contrast detecting method, and
wherein the second method is a phase-difference detecting method.

20. The image pickup apparatus according to claim 18, wherein the first method is a contrast detecting method, and
wherein the second method is an image-plane phase-difference detecting method that uses image data output from the image sensor.
